(19) United States
(12) Patent Application Publication
(10) Pub. No.: US 2008/0010447 A1
(43) Pub. Date: Jan. 10, 2008

(54) Method for modifying the booting screen of a computer system

(75) Inventor: Chi-Chou Liao, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/808,390

(22) Filed: Jun. 8, 2007

(30) Foreign Application Priority Data
Jul. 6, 2006 (TW) 95124698

(51) Int. Cl. G06F 9/00

(52) U.S. Cl. 713/2

(57) ABSTRACT

A method for modifying the booting screen of a computer system is described. A procedure to verify user identification in an operation system before modifying the booting screen is implemented. A personalized booting image file is edited. The personalized booting image file is converted into the format of the BIOS booting image. The personalized booting image file is saved into the BIOS booting file so as to add a personalized picture in an original booting screen.

### RELATED APPLICATIONS

This application claims priority to Taiwan Application Serial Number 95124698, filed Jul. 6, 2006, which is herein incorporated by reference.

### BACKGROUND

1. Field of Invention

The present invention relates to a method for modifying the booting screen of a computer system.

2. Description of Related Art

BIOS (Basic Input-Output System) is the fundamental firmware in a computer system. BIOS, which mainly includes low level software codes, provides the lowest level tests to peripheral devices in the computer system and preliminary controls the booting procedure, including installing the operating system. For example, BIOS will begin its Power-on self-test (POST) duties when the power of the computer system is turned on. The POST tests the computer system, insuring that it meets the necessary system requirements before booting up.

The conventional BIOS booting procedure contains a booting screen showing a logo or trademark of the BIOS supplier. Neither the computer supplier nor the user can add any logo or personalized picture onto the booting screen.

Recently, some vendors have developed booting screen modifying software based on Windows operation system to insert their logo. However, such a method is still complicated for general users.

### SUMMARY

It is therefore an objective of the present invention to provide a method to modify the booting screen of a computer system.

In accordance with the foregoing and other objectives of the present invention, a method to modify the booting screen of a computer system is provided. The modifying method used to the computer system with a BIOS booting file includes steps as follows. A procedure is used to verify user identification in an operating system before modifying the booting screen. A personalized booting image file is edited. The personalized booting image file is converted into the format of the BIOS booting image. The personalized booting image file is saved into the BIOS booting file so as to insert a personalized picture in the original booting screen.

This method modifies the booting screen of a computer system and allows users to insert pictures with common image formats and input text symbols so as to form a personalized booting screen. Therefore, the inconvenience of preparing BIOS booting image file with specific formats is avoided.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flowchart to modify the booting screen of a computer system according to one preferred embodiment of this invention; and

FIG. 2 illustrates the booting screen of a computer system according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

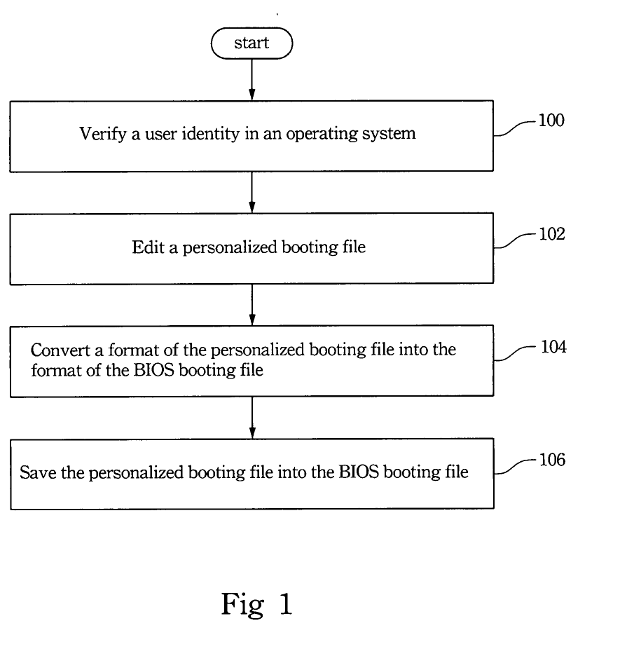

FIG. 1 is a flowchart of the computer system boot screen modification process according to one preferred embodiment of this invention. A BIOS booting file is saved in the computer system. During modifying the booting screen of a computer system, a procedure is needed to verify if the user is the owner of the computer or not. In step 100, users can input a password or verified by some other more complicated method. Once the user passes this verification procedure, the user can start the boot screen modification program.

The above-mentioned computer system boot screen modification program is an API (Application Programming Interface) of a GDI (Graphics Device Interface). When this program is executed based on Windows operation system, a full-screen booting image of 256 colors plus 640×480 pixels is simulated such that user can edit a desired picture on the full-screen booting image. In step 102, users can insert image files and input text symbols form their personalized booting image files. Users can reserve the original trademark or logo of an original booting screen. The common image file format can be used including BMP, JPG, GIF, PNG, PIC, WMF or TIF format.

In step 104, the program snaps the edited full-screen personalized booting screen according to formats of BIOS booting image. In other words, the personalized booting image file generated in step 102 can be converted into the BIOS booting image format. BIOS booting image formats may vary due to different BIOS suppliers. General formats can be of 16 or 256 colors and/or BMP or PCX format. Thus, users need not reboot the computer to preview a real booting screen.

In step 106, the personalized booting image file is saved into the BIOS booting file so as to add a personalized picture in an original booting screen by means of a communication driver between BIOS and Windows operation system. BIOS booting file and its booting image are usually saved into an erasable storage device on a motherboard, such as EEPROM or Flash ROM. Such memory can reserve data without power. New and updated BIOS can be written into such erasable storage devices by electricity such that modifying the booting screen is possible.

Compared to the prior art, the above-mentioned program for modifying the booting screen of a computer system can avoid the inconvenient step of converting edited file into BIOS booting image formats. The full-screen booting image generated by this program is the same as a real booting screen. Thus, users need not reboot the computer to preview a real booting screen.

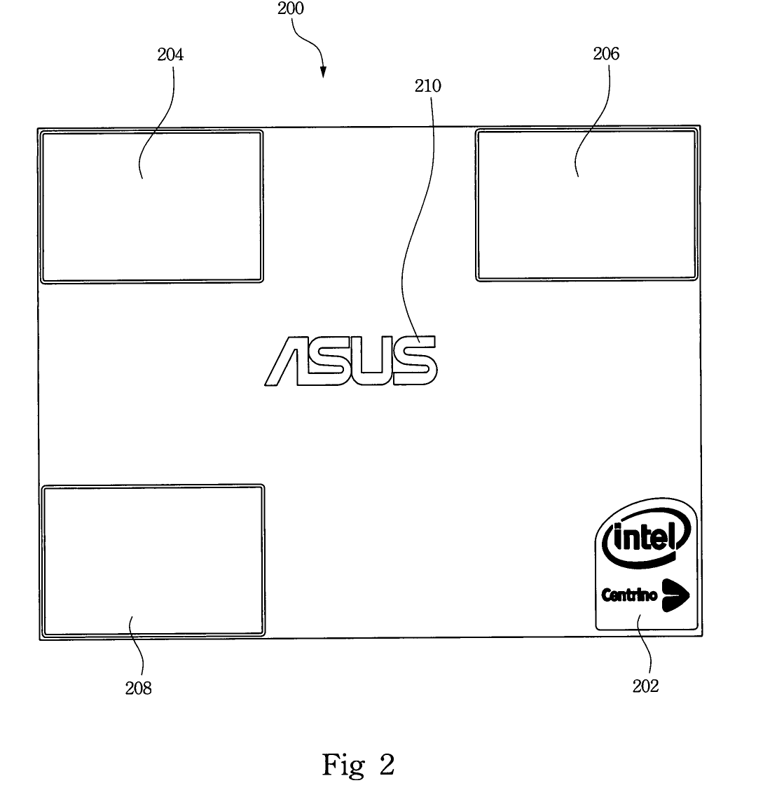

FIG. 2 illustrates the booting screen of a computer system according to one preferred embodiment of this invention. A CPU supplier trademark 202 is located in a right-lower section of this booting screen 200. A PC system supplier trademark 210 is located in the central section of this booting screen 200. Sections 204, 206 and 208 are the places where image files can be inserted. Sections 204, 206 and 208 are not fixed, and should be adjusted to fit into blank portions of an original booting screen.

According to preferred embodiments of the present invention, this method to modify the booting screen of a computer system allows users to insert pictures with common image formats and input symbols so as to form a personalized booting screen.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for modifying the booting screen of a computer system, a BIOS booting file being saved in the computer system, said method comprising:
verifying a user identity in an operating system;
editing a personalized booting image file;
converting a format of the personalized booting image file into the format of the BIOS booting image; and
saving the personalized booting image file into the BIOS booting file.

2. The method of claim 1, wherein the step of editing a personalized booting image file is to simulate a full-screen booting image and edit the personalized booting image.

3. The method of claim 2, wherein the BIOS booting image is an image file of 16 or 256 colors.

4. The method of claim 3, wherein the format of BIOS booting image is BMP or PCX format.

5. The method of claim 1, wherein the step of editing a personalized booting image file is executed based on a Windows operating system.

6. The method of claim 2, wherein the full-screen booting image is a 640×480 pixel image file with 16 or 256 colors.

7. The method of claim 1, wherein the personalized booting image file is saved in a storage device on a motherboard.

8. The method of claim 7, wherein the storage device is an erasable memory.

9. The method of claim 1, wherein the step of editing a personalized booting image file includes inputting text symbols and inserting image files.

10. The method of claim 9, wherein the format of the image files includes BMP, JPG, GIF, PNG, PIC, WMF or TIF format.
